(19) United States
(12) Patent Application Publication
(10) Pub. No.: US 2025/0058789 A1
(43) Pub. Date: Feb. 20, 2025

(54) GATED LOAD BALANCING FOR UNCERTAINTY AWARE CAMERA-LIDAR FUSION

(71) Applicant: QUALCOMM Incorporated, San Diego, CA (US)

(72) Inventors: Balaji Shankar Balachandran, San Diego, CA (US); Varun Ravi Kumar, San Diego, CA (US); Senthil Kumar Yogamani, Headford (IE)

(21) Appl. No.: 18/452,292

(22) Filed: Aug. 18, 2023

(51) Int. Cl. B60W 50/14; G01S 17/89; G06T 7/20; G06T 7/70; G06T 9/00; G06V 10/44

(52) U.S. Cl. CPC B60W 50/14; G01S 17/89; G06T 7/20; G06T 7/70; G06T 9/00; G06V 10/44

(57) ABSTRACT

A system for processing image data and position data, the system comprising: a memory for storing the image data and the position data; and processing circuitry in communication with the memory. The processing circuitry is configured to: apply a first encoder to extract, from the image data, a first set of features; apply a first decoder to determine, based on the first set of features, a first uncertainty score. Additionally, the processing circuitry is configured to apply a second encoder to extract, from the position data, a second set of features; apply a second decoder to determine, based on the second set of features, a second uncertainty score; and fuse the first set of features and the second set of features based on the first uncertainty score and the second uncertainty score.

### TECHNICAL FIELD

This disclosure relates to sensor systems, including sensor systems for advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indictive of the existence and location of other objects around the autonomous driving vehicle. In some examples, such an autonomous driving vehicle may be referred to as an ego vehicle. A vehicle having an advanced driver-assistance systems (ADAS) is a vehicle that includes systems which may assist a driver in operating the vehicle, such as parking or driving the vehicle.

### SUMMARY

The present disclosure generally relates to techniques and devices for fusing image data and position data to generate an output. For example, systems may fuse image data and position data to perform one or more tasks relating to image segmentation, depth detection, object detection, or any combination thereof. Fused sets of image data and position data may be used for a wide variety of tasks including controlling an object (e.g., a vehicle or a robotic arm) within a three-dimensional (3D) environment, generating virtual reality (VR) and augmented reality (AR) content, or other tasks that require image segmentation, depth detection, or object detection.

A 3D environment may, in some examples, include one or more objects. For example, the 3D environment may include one or more vehicles, one or more traffic signs and/or road markers, one or more pedestrians, one or more non-moving objects such as trees, barriers, and fences. A system may collect image data and position data that includes information corresponding to one or more objects within the 3D environment. In some examples, the image data may include one or more camera images that indicate an appearance of the one or more objects. In some examples, the position data may include Light Detection and Ranging (LiDAR) data that indicates a position of the one or more objects.

The system may process the image data and the position data in order to generate an output. The system may, in some cases, apply encoders to extract features from the image data and the position data that is useful for performing one or more actions. For example, when the image data indicates a stop sign and the position data indicates that the stop sign is 50 feet away, it may be beneficial for the system to process the image data and the position data to identify the stop sign and perform one or more actions based on the presence of the stop sign and the location of the stop sign. To process the image data and the position data, the system may fuse features extracted from the image data with features extracted from the position data. The system may apply a decoder, using the fused features as an input, to generate an output.

Several factors may affect a reliability of image data and position data collected by the system. For example, adverse weather conditions may affect a reliability of image data and/or position data collected by the system, but adverse weather conditions may affect a reliability of image data more than adverse weather conditions affect a reliability of position data. For example, adverse weather conditions such as heavy rain or fog may obscure a stop sign in image data captured by the system, but LiDAR data may reliably indicate a position of the stop sign in the same adverse weather conditions that obscure the stop sign in image data. It may be beneficial for the system to identify a reliability of image data and position data and fuse extracted features based on the identified reliability so that the system avoids relying on unreliable data.

The system may identify a reliability of image data and position data using one or more techniques. For example, when an encoder processes input image data and/or position data to extract features, an activation density corresponding to the encoder may indicate an extent to which the input data indicates characteristics of a 3D environment surrounding the system. Activation density may represent a ratio of active nodes to a total number of nodes of the encoder. A higher activation ratio may correspond to data that is more informative of one or more objects in a 3D space as compared with a lower activation ratio. For example, since an encoder is trained to use nodes to extract useful information from data, an encoder may generate a greater amount of useful information when using a greater portion of its nodes as compared with the amount of useful information that the encoder generates when using a lesser portion of its nodes.

The system may additionally or alternatively use a decoder to determine an uncertainty score corresponding to features extracted from image data and use a decoder to calculate an uncertainty score corresponding to features extracted from position data. An uncertainty score corresponding to extracted features may indicate an amount of confidence that the extracted features accurately represent the data from which the features were extracted. The system may use uncertainty scores and activation densities corresponding to image data and position data to fuse features with different weightings corresponding to image data and position data in a way that generates an output that more precisely accounts for image and position data reliability as compared with systems that do not use uncertainty scores and activation densities.

The techniques of this disclosure may result in an improved output from position and image data fusion by processing image data and position data as compared with other systems that fuse image data and position data to generate an output. For example, by identifying uncertainty scores corresponding to features extracted from image data and position data, the system may fuse the features extracted from the image data and the features extracted from the position data in a way that causes a decoder to generate a higher quality output as compared with systems that do not calculate uncertainty scores corresponding to extracted features. Furthermore, by identifying activation densities corresponding to encoders that extract features from image data and position data, the system may fuse the features extracted from the image data and the features extracted from the position data in a way that causes a decoder to generate a higher quality output as compared with systems that do not use activation densities to fuse features.

In one example, this disclosure describes a system for processing image data and position data, the system comprising: a memory for storing the image data and the position data; and processing circuitry in communication with the memory. The processing circuitry is configured to: apply a first encoder to extract, from the image data, a first set of features; apply a first decoder to determine, based on the first set of features, a first uncertainty score corresponding to a first confidence that the first set of features accurately represent the image data; apply a second encoder to extract, from the position data, a second set of features; apply a second decoder to determine, based on the second set of features, a second uncertainty score corresponding to a second confidence that the second set of features accurately represent the position data; and fuse the first set of features and the second set of features based on the first uncertainty score and the second uncertainty score to generate a fused set of features.

In another example, this disclosure describes a method for processing image data and position data, the method comprising: executing a first encoder to extract, from the image data, a first set of features; and executing a first decoder to determine, based on the first set of features, a first uncertainty score corresponding to a first confidence that the first set of features accurately represent the image data. Additionally, the method comprises executing a second encoder to extract, from the position data, a second set of features; executing a second decoder to determine, based on the second set of features, a second uncertainty score corresponding to a second confidence that the second set of features accurately represent the position data; and fusing the first set of features and the second set of features based on the first uncertainty score and the second uncertainty score to generate a fused set of features.

In another example, this disclosure describes a computer-readable medium comprising instructions that, when applied by processing circuitry, causes the processing circuitry to: apply a first encoder to extract, from image data, a first set of features; apply a first decoder to determine, based on the first set of features, a first uncertainty score corresponding to a first confidence that the first set of features accurately represent the image data; apply a second encoder to extract, from position data, a second set of features; apply a second decoder to determine, based on the second set of features, a second uncertainty score corresponding to a second confidence that the second set of features accurately represent the position data; and fuse the first set of features and the second set of features based on the first uncertainty score and the second uncertainty score to generate a fused set of features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one to more techniques of this disclosure.

FIG. 2 is a block diagram illustrating an example fusion unit for processing image data and position data to generate an output, in accordance with one to more techniques of this disclosure.

FIG. 3 is a block diagram illustrating a first set of bird's eye view (BEV) features, second set of BEV features, and a data fusion unit configured to reweigh the first set of BEV features and the second set of BEV features, in accordance with one to more techniques of this disclosure.

FIG. 4 is a flow diagram illustrating an example method for calculating uncertainty scores for fusing image data features and position data features, in accordance with one or more techniques of this disclosure.

### DETAILED DESCRIPTION

Camera and Light Detection and Ranging (LiDAR) systems may be used together in various different robotic and vehicular applications. One such vehicular application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and relative speed of objects around the vehicle. LiDAR sensors provide three-dimensional (3D) data, enabling the ADAS to create a detailed map of the surrounding environment. LiDAR may be particularly effective in low-light or adverse weather conditions, where camera performance may be hindered. In some examples, the output of a LiDAR sensor may be used as partial ground truth data for performing neural network-based depth information on corresponding camera images.

By fusing the data gathered from both camera and LiDAR sensors, an ADAS or another kind of system can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

The present disclosure generally relates to techniques and devices for fusing position data collected by a LiDAR sensor (e.g., a 3D point cloud) and image data captured by a camera (e.g., a two-dimensional (2D) image). As described above, cameras and LiDAR sensors may be used in vehicular and/or robotic applications as sources of information that may be used to determine the location, pose, and potential actions of physical objects in the outside world. However, features extracted from data collected by these sensors may vary in reliability. As such, it may be beneficial for a system to monitor a reliability of features extracted from image data and position data when using these features to generate an output for controlling a vehicle. This disclosure describes techniques for fusing features extracted from the output of LiDAR sensors and features extracted from the output of cameras such that the output generated using the fused features better accounts for uncertainty.

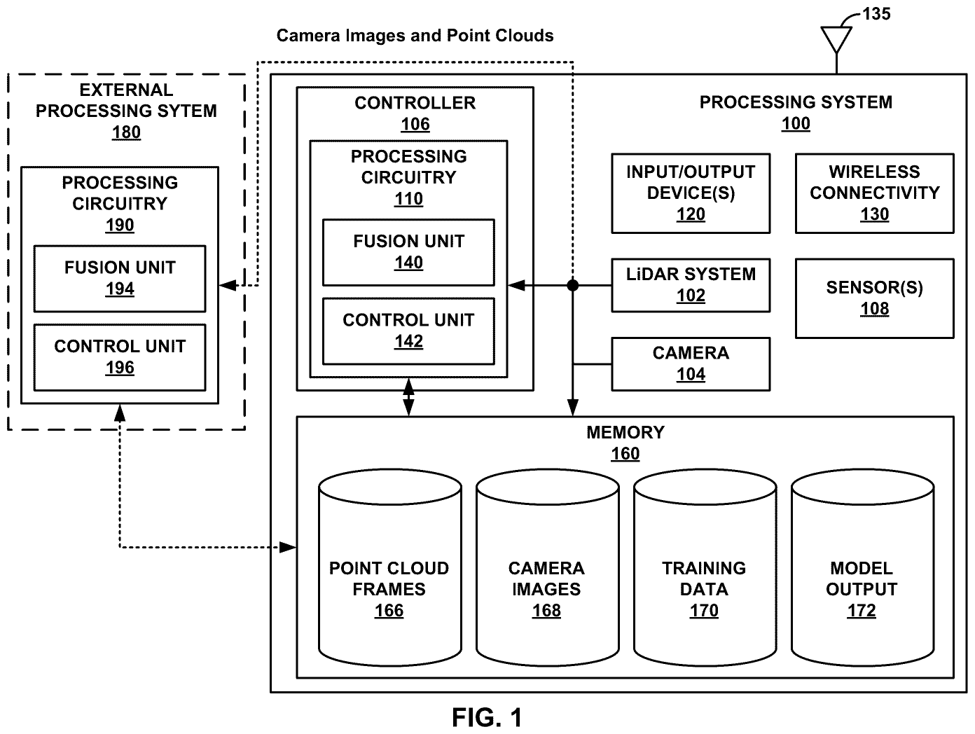

FIG. 1 is a block diagram illustrating an example processing system 100, in accordance with one to more techniques of this disclosure. Processing system 100 may be used in a vehicle, such as an autonomous driving vehicle or an assisted driving vehicle (e.g., a vehicle having an advanced driver-assistance systems (ADAS) or an “ego vehicle”). In such an example, processing system 100 may represent an ADAS. In other examples, processing system 100 may be used in other robotic applications that may include both a camera and a LiDAR system. The techniques of this disclosure are not limited to controlling vehicles. The techniques of this disclosure may be applied by any system that fuses image data features and position data features.

Processing system 100 may include LiDAR system 102, camera 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. For example, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside a vehicle. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames mased on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera 104. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 104 may be any type of camera configured to capture video or image data in the environment around processing system 100 (e.g., around a vehicle). In some examples, processing system 100 may include multiple cameras 104. For example, camera 104 may include a front facing camera (e.g., a front bumper camera, a front windshield camera, and/or a dashcam), a back facing camera (e.g., a backup camera), side facing cameras (e.g., cameras mounted in sideview mirrors). Camera 104 may be a color camera or a grayscale camera. In some examples, camera 104 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

Data input modalities such as point cloud frames 166 and camera images 168 perform well under different conditions. Additionally, or alternatively, sensors such as LiDAR system 102 and camera 104 might not always perform reliably even under suitable conditions. That is, conditions in which point cloud frames 166 and camera images 168 are collected and a performance of LiDAR system 102 and camera 104 may affect a quality of point cloud frames 166 and camera images 168 for use in generating an output. It may be beneficial to consider the quality of point cloud frames 166 and camera images 168 when fusing features corresponding to point cloud frames 166 and features corresponding to camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with LiDAR system 102, camera 104, and/or sensor(s) 108. For example, processing circuitry 110 may include one or more image signal processors associated with camera 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

Processing system 100 and/or components thereof may be configured to perform techniques for fusing image data and position data. For example, processing circuitry 110 may include fusion unit 140. Fusion unit 140 may be implemented in software, firmware, and/or any combination of hardware described herein. As will be described in more detail below, fusion unit 140 may be configured to receive a plurality of camera images 168 captured by camera 104 and receive a plurality of point cloud frames 166 captured by LiDAR system 102. Fusion unit 140 may be configured to receive camera images 168 and point cloud frames 166 directly from camera 104 and LiDAR system 102, respectively, or from memory 160. In some examples, the plurality of point cloud frames 166 may be referred to herein as “position data.” In some examples, the plurality of camera images 168 may be referred to herein as “image data.”

In general, fusion unit 140 may fuse features corresponding to the plurality of point cloud frames 166 and features corresponding to the plurality of camera images 168 in order to combine image data corresponding to one or more objects within a three-dimensional (3D) space with position data corresponding to the one or more objects. For example, each camera image of the plurality of camera images 168 may comprise a 2D array of pixels that includes image data corresponding to one or more objects. Each point cloud frame of the plurality of point cloud frames 166 may include a 3D multi-dimensional array of points corresponding to the one or more objects. Since the one or more objects are located in the same 3D space where processing system 100 is located, it may be beneficial to fuse features of the image data present in camera images 168 that indicate information corresponding to the identity one or more objects with features of the position data present in the point cloud frames 166 that indicate a location of the one or more objects within the 3D space. This is because image data may include at least some information that position data does not include, and position data may include at least some information that image data does not include.

Fusing features of image data and features of position data may provide a more comprehensive view of a 3D environment corresponding to processing system 100 as compared with analyzing features of image data and features of position data separately. For example, the plurality of point cloud frames 166 may indicate an object in front of an object corresponding to processing system 100, and fusion unit 140 may be able to process the plurality of point cloud frames 166 to determine that the object is a stoplight. This is because the plurality of point cloud frames 166 may indicate that the object has three round objects oriented vertically and/or horizontally relative to a surface of a road intersection, and the plurality of point cloud frames 166 may indicate that the size of the object is within a range of sizes that stoplights normally occupy. But the plurality of point cloud frames 166 might not include information that indicates which of the three lights of the stoplight is turned on and which of the three lights of the stoplight is turned off. Camera images 168 may include image data indicating that a green light of the stoplight is turned on, for example. This means that it may be beneficial to fuse features of image data with features of position data so that fusion unit 140 can analyze image data and position data to determine characteristics of one or more objects within the 3D environment.

Fusion unit 140 may be configured to extract features from point cloud frames 166 and/or extract features from camera images 168 in order to identify one or characteristics of one or more objects within a 3D environment. For example, fusion unit 140 may apply a first encoder to extract, from camera images 168, a first set of features. Additionally, or alternatively, fusion unit may apply a second encoder to extract, from point cloud frames 166, a second set of features. An encoder may include one or more nodes that map input data into a representation of the input data in order to “extract” features of the data. Features may represent information output from the encoder that indicates one or more characteristics of the data. It may be beneficial for an encoder to output features of input data that accurately represent the input data. For example, it may be beneficial for an encoder to accurately output features that identify one or more characteristics of objects within the 3D environment.

Environmental conditions and other conditions may affect an extent to which fusion unit 140 can reliably and accurately extract features from point cloud frames 166 and camera images 168. For example, one or more weather conditions may adversely impact data collection by LiDAR system 102 and camera 104 such that an ability of fusion unit 140 to accurately extract features from point cloud frames 166 and camera images 168 is negatively affected. For example, if there is fog in the 3D environment corresponding to processing system 100, one or more objects in the 3D environment may be obscured or decreased in prominence in camera images 168. An identity of a traffic sign (e.g., a “stop” sign vs. a “do not enter” sign) might be harder to determine if there is fog in an image including the traffic sign. In some examples, adverse weather conditions may have a greater negative impact on camera images 168 than adverse weather conditions have on point cloud frames 166. This is because lasers emitted and sensed by LiDAR system 102 may have the ability to pierce adverse weather conditions. Other conditions may negatively affect point cloud frames 166 collected by LiDAR system 102 such as topographic variations in terrain, a high number of reflective surfaces, surface reflectivity, and obstructing objects.

Fusion unit 140 may be configured to fuse features extracted from point cloud frames 166 with features extracted from camera images 168 in a way that takes into account a confidence that the features corresponding to each of point cloud frames 166 and camera images 168 accurately represent the point cloud frames 166 and the camera images 168, respectively. One way that fusion unit 140 can determine a confidence in features extracted by input data is to determine an activation density of an encoder that extracts the features. For example, when an encoder extracts features from input data, one or more nodes of the input data may “activate” in order to process the input data and generate the features as an output. The activation density of an encoder may represent a ratio of a total number of active nodes of the encoder when processing input data to a total number of nodes present in the encoder. A higher activation ratio may correspond input data that is more informative of characteristics of the 3D environment surrounding the processing system 100 as compared with the informativeness of input data when the activation ratio of an encoder is low. That is, a high activation density may indicate a rich performance of input data for processing to generate an output. Fusion unit 140 may be configured to leverage activation densities associated with encoders to adaptively fuse multi-modal information.

In some examples, by executing a first encoder to extract a first set of features from camera images 168, fusion unit 140 may determine a first activation density representing a ratio of a number of active nodes of the first encoder to a total number of nodes in the first encoder. Additionally, or alternatively, by executing a second encoder to extract a second set of features from point cloud frames 166, fusion unit 140 may determine a second activation density representing a ratio of a number of active nodes of the second encoder to a total number of nodes in the first encoder. The first activation density may represent an informativeness of camera images 168 concerning characteristics of a 3D environment corresponding to processing system 100.

When camera images 168 are more informative, the first encoder may extract features that indicate a greater amount of information concerning the 3D environment corresponding to processing system 100 as compared with an amount of information indicated by features extracted by the first encoder when camera images 168 are less informative. The second activation density may represent an informativeness of point cloud frames 166 concerning characteristics of a 3D environment corresponding to processing system 100. When point cloud frames 166 are more informative, the second encoder may extract features that indicate a greater amount of information concerning the 3D environment corresponding to processing system 100 as compared with an amount of information indicated by features extracted by the second encoder when point cloud frames 166 are less informative.

A high activation density corresponding to an encoder may indicate that an informativeness of input data to the encoder concerning the 3D environment is high, and therefore the input data is more useful for processing to generate an output. A low activation density corresponding to an encoder may indicate that an informativeness of input data to the encoder concerning the 3D environment is low, and therefore the input data is less useful for processing to generate an output. This means that it may be beneficial to identify an activation ratio of an encoder as the encoder processes input data so that features extracted from the input data can be reweighed based on the informativeness of the input data.

Before fusion unit 140 fuses features extracted from point cloud frames 166 and features extracted from camera images 168, fusion unit 140 may, in some examples, transform the features extracted from point cloud frames 166 and features extracted from camera images 168 into bird's eye view (BEV) features. In examples where processing system 100 is part of an ADAS for controlling a vehicle, it may be beneficial to transform extracted features into BEV features so that processing system 100 is more effectively able to control the vehicle's movement across the ground. For example, a ground vehicle may move across the ground without moving vertically above or below the ground. This means that transforming features extracted from the input data into BEV features may assist processing system 100 in controlling the vehicle to move based on a location of the vehicle from a perspective looking down at the ground relative to one or more objects from a perspective looking down at the ground.

The first set of features extracted by the first encoder from camera images 168 may, in some cases, represent perspective view features that include information corresponding to one or more objects within the 3D space corresponding to processing system 100 from the perspective of camera 104 within the 3D space. That is, the first set of features may include information corresponding to one or more objects within the 3D space from a perspective of the location of camera 104 looking at the one or more objects. Fusion unit 140 may, in some examples, project the first set of features extracted by the first encoder from camera images 168 onto a 2D grid such that the first set of features are transformed into a first set of BEV features. The first set of BEV features may represent information corresponding to the one or more objects within the 3D space from a perspective above the one or more objects looking down at the one or more objects.

The second set of features extracted by the second encoder from point cloud frames 166 may, in some cases, represent 3D sparse features that indicate distinctive characteristics of point cloud frames 166. Since point cloud frames 166 represent multi-dimensional arrays of data, the 3D sparse features extracted from point cloud frames 166 indicate information of one or more objects within a 3D environment. Fusion unit 140 may flatten the 3D sparse features such that the second set of features are transformed into a second set of BEV features. The second set of BEV features may include information indicated by the 3D sparse features from a perspective above one or more objects within a 3D space looking down at the one or more objects within the 3D space.

To determine a certainty that a set of BEV features accurately represents data input into an encoder, fusion unit 140 may apply one or more decoders to process the set of BEV features to generate an uncertainty score. An uncertainty score may represent a confidence that a set of BEV features accurately identify one or more characteristics of the data input to the encoder. In some examples, an encoder may process input data and generate a set of features that are a representation of the input data, and an encoder may process the set of features and generate an output that reconstructs the original data input to the encoder. When an encoder generates a set of features that do not accurately represent the input data, data output from the decoder based on the set of features might not fully map to the input data. Since both the data input to an encoder and the data output from a decoder are both known to processing system 100, fusion unit 140 may determine an uncertainty score by comparing data input to an encoder to generate a set of features with data output from a decoder based on processing the set of features. In some examples, an uncertainty score generated by fusion unit 140 may represent a unimodal uncertainty score configured for performing multi-level fusion.

Fusion unit 140 may apply a first decoder to process the first set of BEV features corresponding to camera images 168. In some examples, the first decoder may generate an output that reconstructs the first set of BEV features into an output dataset that is the same as or similar to the camera images 168 input to the first encoder. Fusion unit 140 may compare the data output from the first decoder with the camera images 168 input to the first encoder to determine a first uncertainty score that indicates a confidence that the first set of BEV features accurately represent the camera images 168, but this is not required. Fusion unit 140 may determine the first uncertainty score without comparing the input to the first encoder with the output from the first decoder.

Fusion unit 140 may apply a second decoder to process the second set of BEV features corresponding to point cloud frames 166. In some examples, the second decoder may generate an output that reconstructs the second set of BEV features into an output dataset that is the same as or similar to the point cloud frames 166 input to the second encoder. Fusion unit 140 may compare the data output from the second decoder with the point cloud frames 166 input to the second encoder to determine a second uncertainty score that indicates a confidence that the second set of BEV features accurately represent the point cloud frames 166, but this is not required. Fusion unit 140 may determine the second uncertainty score without comparing the input to the second encoder with the output from the second decoder.

In some examples, fusion unit 140 may fuse the first set of BEV features with the second set of BEV features based on the first activation density from the first encoder, the second activation density from the second encoder, the first uncertainty score from the first decoder, the second uncertainty score from the second decoder, or any combination thereof. Fusing the first set of BEV features corresponding to camera images 168 and the second set of BEV features based on the activation densities and the uncertainty scores may improve a robustness of the fused features, because the activation densities and uncertainty scores indicate an extent to which each set of BEV features reliably indicates characteristics of the 3D environment.

To fuse the first set of BEV features corresponding to camera images 168 with the second set of BEV features corresponding to point cloud frames 166, fusion unit 140, in some examples, calculates a first reweight value for the first set of BEV features based on the first activation density and the first uncertainty score and calculates a second reweight value based on the second activation density and the second uncertainty score. Since an activation ratio indicates an informativeness of data input to an encoder concerning characteristics of the 3D environment, and an uncertainty score indicates a confidence that features generated by an encoder accurately represent the input data to the encoder, a reweight value based on an activation ratio and an uncertainty score may provide a comprehensive picture of a quality of a set of features. That is, a reweight value may indicate an extent to which processing system 100 should rely on a set of features to generate an output. A high reweight value may indicate that a set of features is highly reliable for use to generate an output and a low reweight value may indicate that a set of features is not reliable for use to generate an output.

In some examples, fusion unit 140 may calculate a first reweight value by calculating a sum of a first activation density of a first encoder when generating a first set of features corresponding to the camera images 168 and a first uncertainty score corresponding to a confidence that a first set of BEV features accurately represent the camera images 168 input to the first encoder. In some examples, fusion unit 140 may calculate a second reweight value by calculating a sum of a second activation density of a second encoder when generating a second set of features corresponding to the point cloud frames 166 and a second uncertainty score corresponding to a confidence that a second set of BEV features accurately represent the point cloud frames 166 input to the second encoder. Fusion unit 140 is not limited to calculating the first reweight value by calculating the sum of the first activation density and the first uncertainty score and fusion unit 140 is not limited to calculating the second reweight value by calculating the sum of the second activation density and the second uncertainty score. Fusion unit 140 may calculate the first reweight value and the second reweight value using any mathematical operation or equation.

When fusing the first set of BEV features and the second set of BEV features, fusion unit 140 may apply a first reweight value to the first set of BEV features to generate a first set of reweighed BEV features and apply a second reweight value to the second set of BEV features to generate a second set of reweighed BEV features. Since the first reweight value indicates the extent to which processing system 100 can rely on the first set of BEV features corresponding to image data for generating an output and the second reweight value indicates the extent to which processing system 100 can rely on the second set of BEV features corresponding to position data for generating an output, fusion unit 140 may fuse the first set of reweighed BEV features and the second set of reweighed BEV features in a way that accounts for the reliability of each set of features. For example, if the first reweight value corresponding to the first set of BEV features is lower than the second reweight value corresponding to the second set of BEV features, fusion unit 140 may fuse the first set of reweighed BEV features and the second set of reweighed BEV features in a way that relies more on the second set of BEV features for generating an output and relies less on the first set of BEV features.

In some examples, fusion unit 140 may apply the first reweight value to the first set of BEV features by multiplying the first reweight value with the first set of BEV features to generate the first set of reweighed BEV features. In some examples, fusion unit 140 may apply the second reweight value to the second set of BEV features by calculating a product of the second reweight value with the second set of BEV features to generate the second set of reweighed BEV features. This means that a set of reweighted BEV features may be more prominent when the reweight value is higher as compared with when the reweight value is lower. Fusion unit 140 is not limited to generating a set of reweighed BEV features by multiplying a reweight value with a set of BEV features. Fusion unit 140 may use any mathematical operation to generate sets of reweighed BEV features.

Fusion unit 140 may fuse the first set of reweighed BEV features with the second set of reweighed BEV features. Fusing the first set of reweighed BEV features and the second set of reweighed BEV features may associate information corresponding to characteristics of camera images 168 with information corresponding to characteristics of point cloud frames 166. The reweighted sets BEV features are given weighed based on their reliability for generating an output. That means that when environmental conditions or other conditions decrease a quality of point cloud frames 166 and/or camera images 168, features extracted from lower-quality data are not relied on as heavily for generating the output.

Fusion unit 140 may output the fused sets of reweighed BEV features to a third decoder for processing. In some examples, the third decoder may be separate from the first decoder applied to determine the first uncertainty score corresponding to the first set of BEV features and the second decoder applied to determine the second uncertainty score corresponding to the second set of BEV features. Fusion unit 140 may apply the third decoder to process the fused sets of reweighed BEV features to generate an output corresponding to processing system 100. In some examples, the third decoder is configured to transform the fused sets of reweighed BEV features that represent combined data encoded by the first encoder and the second encoder to construct an output that represents a combination of point cloud frames 166 and camera images 168. For example, the output from the third encoder may represent a 3D representation and or a bird's eye view representation of one or more objects within a 3D space including position data indicating a location of the objects relative to the processing system 100 and image data indicating an identity of the objects.

In some examples, processing circuitry 110 may be configured to train one or more encoders and/or decoders applied by fusion unit 140 using training data 170. For example, training data 170 may include one or more training point cloud frames and/or one or more camera images. Training data 170 may additionally or alternatively include features known to accurately represent one or more point cloud frames and/or features known to accurately represent one or more camera images. This may allow processing circuitry to train an encoder to generate features that accurately represent point cloud frames and train an encoder to generate features that accurately represent camera images. Processing circuitry 110 may also use training data 170 to train one or more decoders.

Processing circuitry 110 of controller 106 may apply control unit 142 to control, based on the output generated by fusion unit 140 by applying the third decoder to the fused sets of reweighed BEV features, an object (e.g., a vehicle, a robotic arm, or another object that is controllable based on the output from fusion unit 140) corresponding to processing system 100. Control unit 142 may control the object based on information included in the output generated by fusion unit 140 relating to one or more objects within a 3D space including processing system 100. For example, the output generated by fusion unit 140 may include an identity of one or more objects, a position of one or more objects relative to the processing system 100, characteristics of movement (e.g., speed, acceleration) of one or more objects, or any combination thereof. Based on this information, control unit 142 may control the object corresponding to processing system 100. The output from fusion unit 140 may be stored in memory 160 as model output 172.

The techniques of this disclosure may also be performed by external processing system 180. That is, encoding input data, transforming features into BEV features, weighing features, fusing features, and decoding features, may be performed by a processing system that does not include the various sensors shown for processing system 100. Such a process may be referred to as “offline” data processing, where the output is determined from a set of test point clouds and test images received from processing system 100. External processing system 180 may send an output to processing system 100 (e.g., an ADAS or vehicle).

External processing system 180 may include processing circuitry 190, which may be any of the types of processors described above for processing circuitry 110. Processing circuitry 190 may include fusion unit that is configured to perform the same processes as fusion unit 140. Processing circuitry 190 may acquire point cloud frames 166 and camera images 168 directly from LiDAR system 102 and camera 104, respectively, or from memory 160. Though not shown, external processing system 180 may also include a memory that may be configured to store point cloud frames, camera images, model outputs, among other data that may be used in data processing. Fusion unit 194 may be configured to perform any of the techniques described as being performed by fusion unit 140. Control unit 196 may be configured to perform any of the techniques described as being performed by control unit 142.

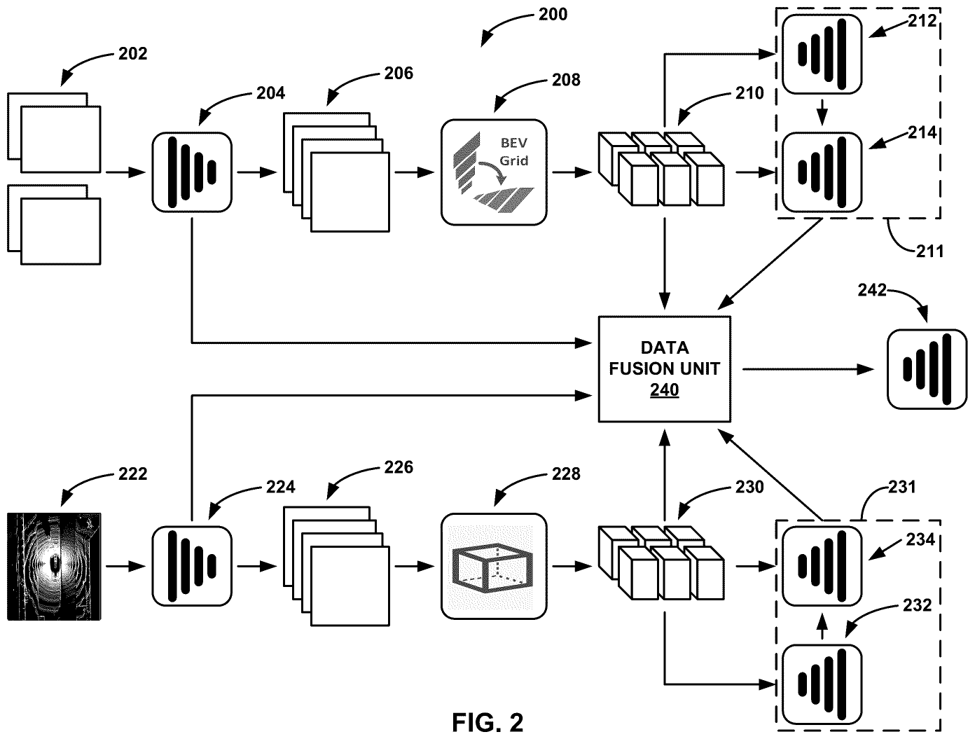

FIG. 2 is a block diagram illustrating an example fusion unit 200 for processing image data and position data to generate an output, in accordance with one to more techniques of this disclosure. In some examples, fusion unit 200 may be an example of fusion unit 140 and/or fusion unit 194 of FIG. 1. FIG. 2 illustrates camera images 202, first encoder 204, perspective view features 206, projection unit 208, first set of BEV features 210, first decoder unit 211 including decoder 212, and decoder 214, point cloud frames 222, second encoder 224, 3D sparse features 226, flattening unit 228, second set of BEV features 230, second decoder unit 231 including decoder 232 and decoder 234, data fusion unit 240, and third decoder unit 242.

Camera images 202 may be examples of camera images 168 of FIG. 1. In some examples, camera images 202 may represent a set of camera images from camera images 168 and camera images 168 may include one or more camera images that are not present in camera images 202. In some examples, camera images 202 may be received from a plurality of cameras at different locations and/or different fields of view, which may be overlapping. In some examples, fusion unit 200 processes camera images 202 in real time or near real time so that as camera 104 captures camera images 202, fusion unit 200 processes the captured camera images. In some examples, camera images 202 may represent one or more perspective views of one or more objects within a 3D space where processing system 100 is located. That is, the one or more perspective views may represent views from the perspective of processing system 100.

Fusion unit 200 including encoders 204, 224 and decoders 212, 214, 232, 234, 242 may be part of an encoder-decoder architecture for processing image data and position data. An encoder-decoder architecture for image feature extraction is commonly used in computer vision tasks, such as image captioning, image-to-image translation, and image generation. The encoder-decoder architecture may transform input data into a compact and meaningful representation known as a feature vector that captures salient visual information from the input data. The encoder may extract features from the input data, while the decoder reconstructs the input data from the learned features.

In some cases, an encoder is built using convolutional neural network (CNN) layers to analyze input data in a hierarchical manner. The CNN layers may apply filters to capture local patterns and gradually combine them to form higher-level features. Each convolutional layer extracts increasingly complex visual representations from the input data. These representations may be compressed and downsampled through operations such as pooling or strided convolutions, reducing spatial dimensions while preserving essential information. The final output of the encoder may represent a flattened feature vector that encodes the input data's high-level visual features.

A decoder may be built using transposed convolutional layers or fully connected layers, may reconstruct the input data from the learned feature representation. A decoder may take the feature vector obtained from the encoder as input and processes it to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During training, an encoder-decoder architecture for feature extraction is trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Encoders and decoders of the encoder-decoder architecture may be trained using training data 170.

An encoder-decoder architecture for image and/or position feature extraction may comprise one or more encoders that extract high-level features from the input data and one or more decoders that reconstruct the input data from the learned features. This architecture may allow for the transformation of input data into compact and meaningful representations. The encoder-decoder framework may enable the model to learn and utilize important visual and positional features, facilitating tasks like image generation, captioning, and translation.

First encoder 204 may represent an encoder of a neural network or another kind of model that is configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

In some examples, the first encoder 204 represents a CNN, another kind of artificial neural network (ANN), or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

When first encoder 204 processes camera images 202 to extract one or more features, one or more nodes of first encoder 204 may be “active” when extracting features from the camera images 202. A ratio of a number of nodes of first encoder 204 that are active when processing input data to a total number of nodes of first encoder 204 may be referred to as an “activation density.” Activation values and activation density in a forward pass of a network may be an indicator of informativeness of a specific modality such as camera images, LiDAR, or radar. In some examples, fusion unit 200 may calculate an activation density for each modality to estimate an informativeness (a) as follows. Activation density may also be referred to as “overall activation occupancy volume.” Activation density may, in some examples, be calculated using the following equation:

$$α = \frac{Number of Active Nodes in Encoder}{Total Number of Nodes in Encoder} \qquad ( eq . 1 )$$

The total number of nodes active in an encoder may comprise a total number of nudes that are active in an encoder (e.g., first encoder 204) when the encoder is processing input data to extract features. The total number of nodes in the encoder may represent a total number of nodes across all layers of the encoder. In some examples, first encoder 204 may have a higher activation density when processing camera images 202 to extract features that are more informative of one or more characteristics of camera images 202 as compared with an activation density of first encoder 204 when processing camera images 202 to extract features that are less informative of one or more characteristics of camera images 202. That is, a higher proportion of the total number of nodes of first encoder 204 may be active when processing input data to generate features that are more informative of the input data, and a lower proportion of the total number of nodes of first encoder 204 may be active when processing input data to generate features that are less informative of the input data.

As used herein, the term “informativeness” may refer to the extent to which an input data modality (e.g., camera images 202 and/or point cloud frames 222) identify characteristics of a 3D environment corresponding to fusion unit 200. For example, when camera images 202 indicate a 3D environment including one or more pedestrians, vehicles, road signs, road indicators, and other objects to a high level of informativeness, first encoder 204 may be configured to generate a set of features to indicate a high amount of information concerning characteristics of the one or more objects and first encoder 204 may have a high activation density when processing camera images 202. In other examples, conditions such as adverse weather may decrease an informativeness of camera images 202 by decreasing a prevalence of one or more objects within camera images 202. This may cause first encoder 204 to generate a set of features that include less information concerning the one or more objects in the 3D environment as compared with examples where camera images 202 are more informative.

First encoder 204 may generate a set of perspective view features 206 based on camera images 202. Perspective view features 206 may provide information corresponding to one or more objects depicted in camera images 202 from the perspective of camera 104 which captures camera images 202. For example, perspective view features 206 may include vanishing points and vanishing lines that indicate a point at which parallel lines converge or disappear, a direction of dominant lines, a structure or orientation of objects, or any combination thereof. Perspective view features 206 may include key points that are matched across a group of two or more camera images of camera images 202. Key points may allow fusion unit 200 to determine one or more characteristics of motion and pose of objects. Perspective view features 206 may, in some examples, include depth-based features that indicate a distance of one or more objects from the camera, but this is not required. Perspective view features 206 may include any one or combination of image features that indicate characteristics of camera images 202.

It may be beneficial for fusion unit 200 to transform perspective view features 206 into 2D features that represent the one or more objects within the 3D environment on a grid from a perspective looking down at the one or more objects from a position above the one or more objects. Since fusion unit 200 may be part of an ADAS for controlling a vehicle, and since vehicles move generally across the ground in a way that is observable from a bird's eye perspective, generating BEV features may allow a control unit (e.g., control unit 142 and/or control unit 196) of FIG. 1 to control the vehicle based on the representation of the one or more objects from a bird's eye perspective. Fusion unit 200 is not limited to generating BEV features for controlling a vehicle. Fusion unit 200 may generate BEV features for controlling another object such as a robotic arm and/or perform one or more other tasks involving image segmentation, depth detection, object detection, or any combination thereof.

Projection unit 208 may transform perspective view features 206 into a first set of BEV features 210. In some examples, projection unit 208 may generate a 2D grid and project the perspective view features 206 onto the 2D grid. For example, projection unit 208 may perform perspective transformation to place objects closer to the camera on the 2D grid and place objects further form the camera on the 2D grid. In some examples, the 2D grid may include a predetermined number of rows and a predetermined number of columns, but this is not required. Projection unit 208 may, in some examples, set the number of rows and the number of columns. In any case, projection unit 208 may generate the first set of BEV features 210 that represent information present in perspective view features 206 on a 2D grid including the one or more objects from a perspective above the one or more objects looking down at the one or more objects.

Fusion unit 200 may apply first decoder unit 211 to generate an uncertainty score corresponding to the first set of BEV features 210. In some examples, the uncertainty score corresponding to the first set of BEV features 210 represents a confidence that the first set of BEV features 210 accurately represent characteristics of the camera images 202. Additionally, or alternatively, the uncertainty score generated by first decoder unit 211 represents a confidence that the perspective view features 206 accurately represent characteristics of the camera images 202. For example, when the first set of BEV features 210 indicates that there is a stoplight ahead of an object corresponding to fusion unit 200 and indicates that the stoplight is green, the uncertainty score may indicate a level of confidence that the first set of BEV features 210 are correct that there is a stoplight ahead of the object and the stoplight is green.

In some examples, fusion unit 200 may compute uncertainty scores for each modality (e.g., for BEV features corresponding to each of camera images 202 and point cloud frames 222) based on a true class probability for classification. A true class probability may represent a probability that a classification present in features is correct. For example, if features identify an object in camera images 202 as a stop sign, a true class probability may represent a probability that the object identified as a stop sign is actually a stop sign. In some examples, fusion unit 200 may compute uncertainty scores for each modality based on an intersection over union (IoU) for 3D bounding box estimates. Uncertainty scores for each modality may be referred to as “0.” Fusion unit 200 may adaptively reweight the features based on a and R before passing it on to the cross-attention layers.

Fusion unit 200 may compute, using one or more decoders (e.g., decoders 212, 214, 232, 234), an uncertainty score corresponding to a set of BEV features for a data modality by performing 3D bounding box estimates and determine an intersection over union. For example, fusion unit 200 may apply one or more decoders to reconstruct a set of BEV features into a 2D bird's eye view representation of the input data corresponding to a data modality. When fusion unit 200 reconstructs the set of BEV features. Fusion unit 200 may apply the one or more decoders to perform 3D bounding box estimates. Bounding box estimates measure overlap between two 3D boxes by calculating a ratio of an intersection volume to a total union volume. This ratio may be referred to as an IoU. The IoU may represent a measure of how well the data reconstructed by the one or more decoders aligns with a ground truth (e.g., the data input to an encoder to generate features).

First decoder unit 211 may include one or more decoders of a neural network or another kind of model that is configured to extract information from input data and process the extracted information to generate an output. In general, decoders are configured to receive encoded features as an input and generate a reconstruction of the data input to an encoder as an output. Features output from an encoder may include one or more vectors of numerical data model. These vectors of numerical data may represent the input data in a way that provides information concerning characteristics of the input data. In other words, encoders are configured to process input data to identify characteristics of the input data. A decoder may reconstruct input data, transforming encoded features into the same space or form of data as the data input to the encoder.

In some examples, one or more decoders of the first decoder unit 211 represents a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more special dimensions of the features, increase a complexity of the features, or increase a resolution of the features. A final layer of a decoder may generate a reconstructed output that includes an expanded representation of the features extracted by an encoder.

First decoder unit 211 may include decoder 212 and decoder 214. In some examples, decoder 212 may represent a camera image data decoder that is configured to reconstruct the first set of BEV features 210 into a 2D representation of the information present in camera images 202 from a bird's eye perspective. Decoder 214 may be configured to process the output from decoder 212 to determine an uncertainty score corresponding to a confidence that the first set of BEV features 210 accurately represent the information present in camera images 202. In some examples, decoder 214 may perform a loss calculation by comparing one or more characteristics of the image data input to first encoder 204 with one or more characteristics of the 2D representation output by decoder 214. In some examples, decoder 214 may determine the uncertainty score in part based on the first set of BEV features 210 and the 2D representation output by decoder 212.

Point cloud frames 222 may be examples of point cloud frames 166 of FIG. 1. In some examples, point cloud frames 222 may represent a set of camera images from point cloud frames 166 and point cloud frames 166 may include one or more point cloud frames that are not present in point cloud frames 222. In some examples, fusion unit 200 processes point cloud frames 222 in real time or near real time so that as LiDAR system 102 generates point cloud frames 222, fusion unit 200 processes the captured point cloud frames. In some examples, point cloud frames 222 may represent collections of point coordinates within a 3D space (e.g., x, y, z coordinates within a Cartesian space) where LiDAR system 102 is located. Since LiDAR system 102 is configured to emit light signals and receive light signals reflected off surfaces of one or more objects, the collections of point coordinates may indicate a shape and a location of surfaces of the one or more objects within the 3D space.

Second encoder 224 may represent an encoder of a neural network or another kind of model that is configured to extract information from input data and process the extracted information to generate an output. Second encoder 224 may be similar to first encoder 204 in that both the first encoder 204 and the second encoder 224 are configured to process input data to generate output features. But in some examples, first encoder 204 is configured to process 2D input data and second encoder 224 is configured to process 3D input data. In some examples, processing system 100 is configured to train first encoder 204 using a set of training data of training data 170 that includes one or more training camera images and processing system 100 is configured to train second encoder 224 using a set of training data of training data 170 that includes one or more point cloud frames. That is, processing system 100 may train first encoder 204 to recognize one or more patterns in camera images that correspond to certain camera image perspective view features and processing system 100 may train second encoder 224 to recognize one or more patterns in point cloud frames that correspond to certain 3D sparse features.

In some examples, the second encoder 224 represents a CNN, another kind of ANN, or another kind of model that includes one or more layers and/or nodes. Each layer of the one or more layers may include one or more nodes. When second encoder 224 processes point cloud frames 222 to extract one or more features, one or more nodes of second encoder 224 may be active when extracting features from the point cloud frames 222. An activation density of second encoder 224 may comprise a ratio of a number of nodes of second encoder 224 that are active when processing input data to a total number of nodes of second encoder 224. In some examples, a second encoder 224 may have a higher activation density when processing data that is more informative of characteristics of the 3D environment as compared with an activation density of second encoder 224 when processing data that is less informative of one or more characteristics of the 3D environment.

An informativeness of second encoder 224 may refer to the extent to which first encoder 204 is able to generate features that indicate one or more characteristics of point cloud frames 222. For example, when point cloud frames 222 indicate a 3D environment including one or more pedestrians, vehicles, road signs, road indicators, and other objects clearly, second encoder 224 may be configured to generate a set of features to indicate characteristics of the one or more objects to a high level of informativeness and second encoder 224 may have a high activation density when processing point cloud frames 222. In other examples, when surfaces of one or more objects have low reflectivity such that optical signals emitted by LiDAR system 102 do not reflect as easily off the surfaces as compared with surfaces having high reflectivity, second encoder 224 may be configured to generate a set of features to indicate characteristics of the one or more objects to a low level of informativeness and second encoder 224 may have a low activation density when processing point cloud frames 222.

Second encoder 224 may generate a set of 3D sparse features 226 based on point cloud frames 222. 3D sparse features 226 may provide information corresponding to one or more objects indicated by point cloud frames 222 within a 3D space that includes LiDAR system 102 which captures point cloud frames 222. 3D sparse features 226 may include key points within point cloud frames 222 hat indicate unique characteristics of the one or more objects. For example, key points may include corners, straight edges, curved edges, peaks of curved edges. Fusion unit 200 may recognize one or more objects based on key points. 3D sparse features 226 may additionally or alternatively include descriptors that allow second encoder 224 to compare and track key points across groups of two or more point cloud frames of point cloud frames 222. Other kids of 3D sparse features 226 include voxels and super pixels.

Flattening unit 228 may transform 3D sparse features 226 into a second set of BEV features 230. In some examples, flattening unit 228 may define a 2D grid of cells and project the 3D sparse features onto the 2D grid of cells. For example, flattening unit 228 may project 3D coordinates of 3D sparse features (e.g., cartesian coordinates key points, voxels) onto a corresponding 2D coordinate of the 2D grid of cells. Flattening unit 228 may aggregate one or more sparse features within each cell of the 2D grid of cells. For example, flattening unit 228 may count a number of features within a cell, average attributes of features within a cell, or take a minimum or maximum value of a feature within a cell. Flattening unit 228 may normalize the features within each cell of the 2D grid of cells, but this is not required. Flattening unit 228 may flatten the features within each cell of the 2D grid of cells into a 2D array representation that captures characteristics of the 3D sparse features projected into each cell of the 2D grid of cells.

Second decoder unit 231 may include one or more decoders of a neural network or another kind of model that is configured to extract information from input data and process the extracted information to generate an output. In some examples, one or more decoders of the second decoder unit 231 represents a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more special dimensions of the features, increase a complexity of the features, or increase a resolution of the features. A final layer of a decoder may generate a reconstructed output that includes an expanded representation of the features extracted by an encoder.

Second decoder unit 231 may include decoder 232 and decoder 234. In some examples, decoder 232 may represent a point cloud data decoder that is configured to reconstruct the second set of BEV features 230 into a 2D representation of the information present in point cloud frames 222 from a bird's eye perspective. Decoder 234 may be configured to process the output from decoder 232 to determine an uncertainty score corresponding to a confidence that the second set of BEV features 230 accurately represent the information present in point cloud frames 222. In some examples, decoder 234 may perform a loss calculation by comparing one or more characteristics of the image data input to second encoder 224 with one or more characteristics of the 2D representation output by decoder 232. In some examples, decoder 234 may determine the uncertainty score in part based on the second set of BEV features 230 and the 2D representation output by decoder 232.

Data fusion unit 240 may be configured to fuse the first set of BEV features 210 corresponding to camera images 202 and the second set of BEV features 230 corresponding to point cloud frames 222. In some examples, a condition of camera images 202 may have a downstream effect on a quality of the first set of BEV features 210 for use in generating an output and a condition of point cloud frames 222 may have a downstream effect on a quality of the second set of BEV features 230 for use in generating an output. Data fusion unit 240 may represent a gated load balancing module (GLBM) module that accepts the first set of BEV features 210 and the second set of BEV features 230 from modality-specific encoders and decoders. The GLBM module of data fusion unit 240 may adaptively reweight a modality specific feature and an upscaled fused feature in an uncertainty aware fashion. For example, data fusion unit 240 may reweight features corresponding to a modality based on an activation density (α) of an encoder which generates features based on input data from the modality and an uncertainty score (β) corresponding to BEV features indicating characteristics of the input data from the modality.

For example, the first set of BEV features 210 may more reliably indicate characteristics of a nearby vehicle in an example where camera images 202 depict the vehicle as a bright red car against black pavement in clear weather conditions as compared with a reliability of the first set of BEV features 210 when camera images 202 depict the vehicle as a faint outline of a grey car in foggy conditions. Since a red car against black pavement in clear weather is more prominent in an image than a grey car in foggy conditions, BEV features may indicate characteristics of the red car to a greater degree of confidence than BEV features indicate characteristics of the grey car.

In some examples, the second set of BEV features 230 may more reliably indicate the characteristics of an object in a 3D space in an example where the object includes surfaces with high reflectivity as compared with a reliability to which BEV features 230 indicate characteristics of an object including surfaces with low reflectivity. Since the second set of BEV features 230 indicate characteristics of point cloud frames 222 which are collected by a LiDAR system 102 that reflects optical signals off objects in a 3D space, the reflectivity of the surfaces of the objects affects an extent to which point cloud frames 222 identify the objects. If a surface of an object reflects very few optical signals emitted by LiDAR system 102, point cloud frames 222 may not indicate many points corresponding to that surface and may identify the object with poor resolution or specificity.

Data fusion unit 240 may receive from first encoder 204, a first activation density that indicates a ratio of a number of nodes of first encoder 204 to a total number of nodes of first encoder 204 when first encoder 204 processes camera images 202 to generate perspective view features 206. Data fusion unit 240 may receive from second encoder 224, a second activation density that indicates a ratio of a number of nodes of second encoder 224 to a total number of nodes of second encoder 224 when second encoder 224 processes point cloud frames 222 to generate 3D sparse features 226. Data fusion unit 240 may receive from first decoder unit 211, a first uncertainty score corresponding to a confidence that the perspective view features 206 and/or the first set of BEV features 210 accurately represent characteristics of camera images 202. Data fusion unit 240 may receive from second decoder unit 231, a first uncertainty score corresponding to a confidence that the 3D sparse features 226 and/or the second set of BEV features 310 accurately represent characteristics of camera images 202.

In some examples, data fusion unit 240 may reweigh the first set of BEV features 210 based on one or both of the first activation ratio received from the first encoder 204 and the first uncertainty score received from the first decoder unit 211. The first activation ratio may indicate a usefulness of perspective view features 206 and/or the first set of BEV features 210 for indicating characteristics of camera images 202 and the first uncertainty score may indicate a confidence that perspective view features 206 and/or the first set of BEV features 210 accurately represent camera images 202. Consequently, it may be beneficial to use one or both of the first activation ratio and the first uncertainty score to reweigh the first set of BEV features 210 to emphasize a usefulness of the first set of BEV features 210 for generating an output.

In some examples, data fusion unit 240 may reweigh the second set of BEV features 230 based on one or both of the second activation ratio received from the second encoder 224 and the second uncertainty score received from the second decoder unit 231. The second activation ratio may indicate a usefulness of 3D sparse features 226 and/or the second set of BEV features 230 for indicating characteristics of point cloud frames 222 and the second uncertainty score may indicate a confidence that 3D sparse features 226 and/or the second set of BEV features 230 accurately represent point cloud frames 222. Consequently, it may be beneficial to use one or both of the second activation ratio and the second uncertainty score to reweigh the second set of BEV features 230 to emphasize a usefulness of the second set of BEV features 230 for generating an output.

Data fusion unit 240 may fuse the reweighed first set of BEV features and the reweighed second set of BEV features to create a fused set of BEV features. Since the first set of BEV features 210 may be reweighed based on the first activation ratio and/or the first uncertainty score and the second set of BEV features 230 may be reweighed based on the second activation ratio and/or the second uncertainty score, data fusion unit 240 may emphasize each of the first set of BEV features 310 and the second set of BEV features 230 based on a usefulness of each of the respective set of features for generating an output. BEV features may be more useful for generating an output when the features are more informative of input data and/or there is a higher confidence that the BEV features accurately indicate characteristics of the input data.

Data fusion unit 240 may output the fused set of BEV features to third decoder unit 242. In some examples, third decoder unit 242 may include a decoder that includes a series of transformation layers. Each transformation layer of the set of transformation layers may increase one or more special dimensions of the fused set of BEV features, increase a complexity of the fused set of BEV features, or increase a resolution of the fused set of BEV features. A final layer of the decoder of third decoder unit 242 may generate a reconstructed output that includes an expanded representation of the perspective view features 206 output by first encoder 204 and 3D sparse features 226 output from second encoder 224. In some examples, a GLBM module is introduced at each layer of the third decoder unit 242, where modality-specific features from the modality-specific decoders 212, 214, 232, 234 are used to up-sample the fused set of BEV features from the previous layer using the first uncertainty score and the second uncertainty score. This may allow fusion unit 200 to fuse features in multiple levels by performing early fusion and object level fusion. Fusion unit 200 may perform uncertainty-aware hierarchical fusion which improves a robustness of the multimodal perception system.

In some examples, the first set of BEV features 210 and the second set of BEV features 230 include the same number of rows of cells and the same number of columns of cells. When data fusion unit 240 fuses the reweighed first set of BEV features and the reweighed second set of BEV features, data fusion unit 240 may combine features located in each cell of the cells of the first set of BEV features with the features located in a corresponding cell of the cells of the second set of BEV features. For example, if a cell of the reweighed first set of BEV features includes information indicating a red stoplight and the corresponding cell of the second set of reweighed BEV features indicates a stoplight and a high intensity, the fused cell may indicate an illuminated red stoplight.

Fusion unit 200 may apply third decoder unit 242 to process the fused set of BEV features to generate an output. In some examples, the output from third decoder unit 242 may include a 2D representation of information included in camera images 202 and point cloud frames 222 from a perspective above one or more objects indicated by camera images 202 and point cloud frames 222 looking down at the one or more objects. For example, the output from third decoder unit 242 may include a bird's eye view of one or more roads, intersections, pedestrians, animals, vehicles, traffic signs, trees, buildings, and any other object that is in a 3D environment corresponding to fusion unit 200.

Since the output from third decoder unit 242 includes a bird's eye view of one or more objects that are in a 3D environment corresponding to fusion unit 200, a control unit (e.g., control unit 142 and/or control unit 196 of FIG. 1) may use the output from third decoder unit 242 to control an object (e.g., a vehicle, one or more robotic components) within the 3D environment. For example, when the output from third decoder unit 242 indicates a vehicle ahead of the vehicle, the control unit may control the vehicle to change lanes to pass the other vehicle. In another example, when the output from third decoder unit 242 indicates a stop sign ahead of the vehicle at an intersection, the control unit may control the vehicle to stop at the intersection.

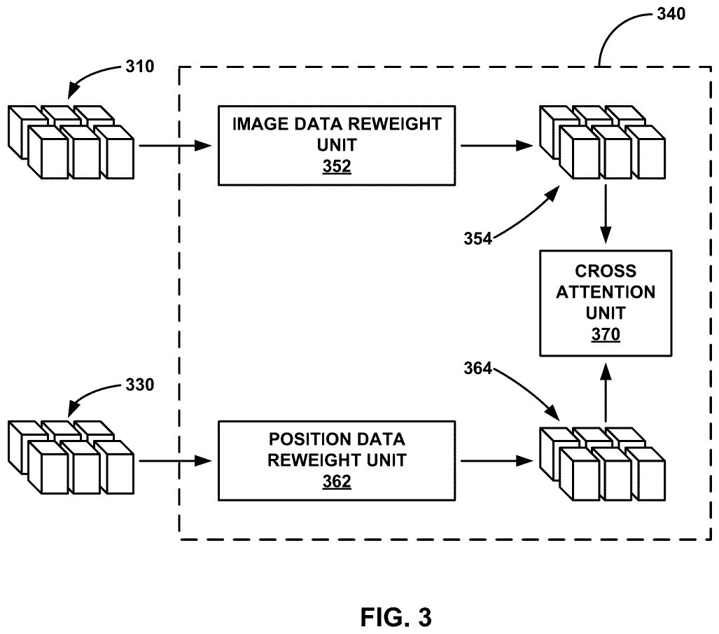

FIG. 3 is a block diagram illustrating a first set of BEV features 310, second set of BEV features 330, and a data fusion unit 340 configured to reweigh the first set of BEV features 310 and the second set of BEV features 330, in accordance with one to more techniques of this disclosure. In some examples, the first set of BEV features 310 is an example of the first set of BEV features 210 of FIG. 2. In some examples, the second set of BEV features 330 is an example of the second set of BEV features 230 of FIG. 2. In some examples, data fusion unit 340 is an example of data fusion unit 240 of FIG. 2. As seen in FIG. 3, data fusion unit 340 includes an image data reweight unit 352, a first set of reweighed BEV features 354, a position data reweight unit 362, a second set of reweighed BEV features 364, and a cross attention unit 370.

Image data reweight unit 352 of data fusion unit 340 may receive the first set of BEV features 310. In some examples, image data reweight unit 352 may receive the activation density of first encoder 204 of FIG. 2 and the first uncertainty score from the first decoder unit 211 of FIG. 2. Image data reweight unit 352 may calculate a first reweight value based on the first activation density and the first uncertainty score. In some examples, image data reweight unit 352 may calculate the first reweight value by calculating a sum of the first activation density and the first uncertainty score, but this is not required. Image data reweight unit 352 may calculate the first reweight value based on the first activation density and the first uncertainty score using any mathematical operation or combination of mathematical operations (e.g., sum, product, subtraction, division, exponential, root).

Image data reweight unit 352 may generate the first set of reweighed BEV features 354 based on the first reweight value and the first set of BEV features 310. In some examples, image data reweight unit 352 may generate the first set of reweighed BEV features 354 by calculating a product of each cell of the first set of BEV features 310 with the first reweight value, but this is not required. Image data reweight unit 352 may use any mathematical operation or combination of mathematical operations to generate the first set of reweighed BEV features 354 based on the first reweight value and the first set of BEV features 310.

Position data reweight unit 362 of data fusion unit 340 may receive the second set of BEV features 330. In some examples, position data reweight unit 362 may receive the activation density of second encoder 224 of FIG. 2 and the second uncertainty score from the second decoder unit 231 of FIG. 2. Position data reweight unit 362 may calculate a second reweight value based on the second activation density and the second uncertainty score. In some examples, position data reweight unit 362 may calculate the second reweight value by calculating a sum of the second activation density and the second uncertainty score, but this is not required. Position data reweight unit 362 may calculate the second reweight value based on the second activation density and the second uncertainty score using any mathematical operation or combination of mathematical operations (e.g., sum, product, subtraction, division, exponential, root).

Position data reweight unit 362 may generate the second set of reweighed BEV features 364 based on the second reweight value and the second set of BEV features 330. In some examples, position data reweight unit 362 may generate the second set of reweighed BEV features 364 by calculating a product of each cell of the second set of BEV features 330 with the second reweight value, but this is not required. Position data reweight unit 362 may use any mathematical operation or combination of mathematical operations to generate the second set of reweighed BEV features 364 based on the second reweight value and the second set of BEV features 330.

In some examples, image data reweight unit 352 may generate the first set of reweighed BEV features 354 and position data reweight unit 362 may generate the second set of reweighed BEV features 364 according to the below equation.

$$BEV Features * ( Activation Density ( α ) + Uncertainty Score ( β ) ) = Reweighed Features \qquad ( eq . 2 )$$

For example, image data reweight unit 352 may generate the first set of reweighed BEV features 354 according to eq. 2 by multiplying the first set of BEV features 310 by a sum of the activation density (α) of first encoder 204 when generating perspective view features 206 with a first uncertainty score (β) corresponding to the first set of BEV features 310. Position data reweight unit 362 may generate the second set of reweighed BEV features 364 according to eq. 2 by multiplying the second set of BEV features 330 by a sum of the activation density (α) of second encoder 224 when generating 3D sparse features 226 with a second uncertainty score (β) corresponding to the second set of BEV features 330.

Cross attention unit 370 may fuse the first set of reweighed BEV features 354 with the second set of reweighed BEV features 364 to create a fused set of BEV features. Since the first set of reweighed BEV features 354 and the second set of reweighed BEV features 364 are each reweighed using respective reweight values calculated based on activation density and an uncertainty score, the fused set of BEV features may emphasize each of image data features and position data features based on the usefulness of the features for generating an output. For example, when the first reweight value calculated by image data reweight unit 352 is greater than the second reweight value calculated by position data reweight unit 362, the first set of BEV features 310 may be emphasized more heavily than the second set of BEV features 330 in the fused set of BEV features.

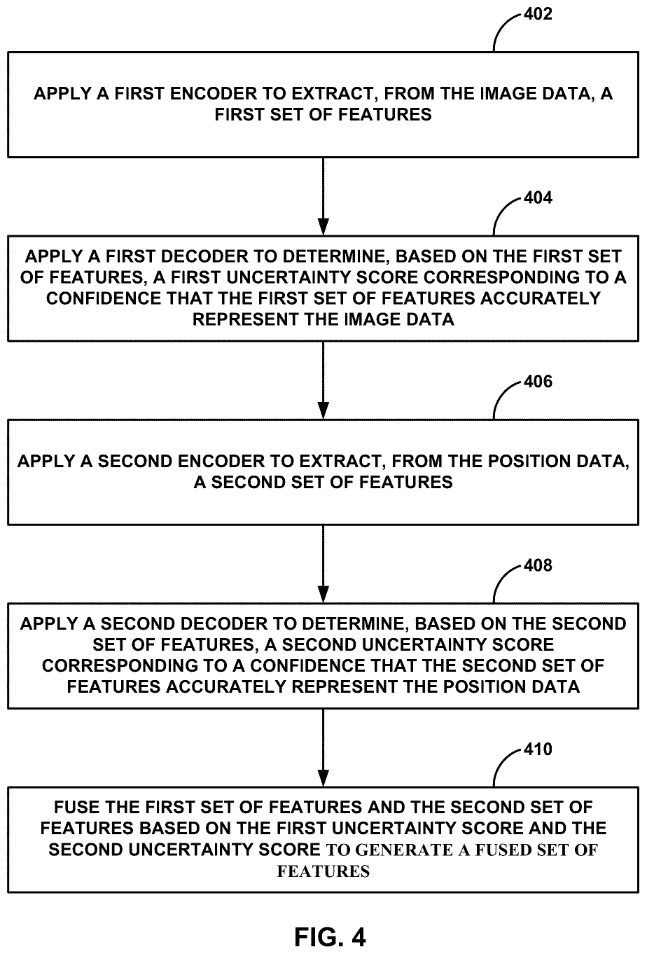

FIG. 4 is a flow diagram illustrating an example method for calculating uncertainty scores for fusing image data features and position data features, in accordance with one or more techniques of this disclosure. FIG. 4 is described with respect to processing system 100 and external processing system 180 of FIG. 1 and fusion unit 200 of FIG. 2. However, the techniques of FIG. 4 may be performed by different components of processing system 100, external processing system 180, and fusion unit 200 or by additional or alternative systems.

Fusion unit 200 may apply first encoder 204 to extract, from image data, a first set of features (402). In some examples, the image data may include camera images 202. Camera images 202 may include one or more camera images from camera images 168. The first set of features may include perspective view features 206 output from the first encoder 204. In some examples, fusion unit 200 may use a projection unit 208 to transform the perspective view features 206 into a first set of BEV features 210. That is, projection unit 208 may transform the perspective view features 206 from the perspective of camera 104 which captures camera images 202 into the first set of BEV features 210 comprising a 2D representation of one or more objects in the camera images 202 from a perspective above the one or more objects looking down at the one or more objects.

Fusion unit 200 may apply a first decoder unit 211 to determine, based on the first set of features, a first uncertainty score corresponding to a confidence that the first set of features accurately represent the image data (404). For example, fusion unit 200 may apply the first decoder unit 211 to the first set of BEV features 210 to generate the first uncertainty score which indicates a confidence that the first set of BEV features 210 accurately represent characteristics of camera images 202.

Fusion unit 200 may apply second encoder 224 to extract, from position data, a second set of features (406). In some examples, the position data may include point cloud frames 222. Point cloud frames 222 may include one or more point cloud frames from point cloud frames 166. The second set of features may include 3D sparse features output from the second encoder 224. In some examples, fusion unit 200 may use a flattening unit 228 to transform the 3D sparse features 226 into a second set of BEV features 230. That is, flattening unit 228 may transform the 3D sparse features 226 from the perspective of LiDAR system 102 which collects point cloud frames 222 into the second set of BEV features 230 comprising a 2D representation of one or more objects in the point cloud frames 222 from a perspective above the one or more objects looking down at the one or more objects.

Fusion unit 200 may apply a second decoder unit 231 to determine, based on the first set of features, a first uncertainty score corresponding to a confidence that the first set of features accurately represent the image data (408). For example, fusion unit 200 may apply the second decoder unit 231 to the second set of BEV features 230 to generate the second uncertainty score which indicates a confidence that the second set of BEV features 230 accurately represent characteristics of point cloud frames 222. Data fusion unit 240 may fuse the first set of features and the second set of features based on the first uncertainty score and the second uncertainty score to generate a fused set of features (410).

Additional aspects of the disclosure are detailed in numbered clauses below.

Clause 1—A system for processing image data and position data, the system comprising: a memory for storing the image data and the position data; and processing circuitry in communication with the memory. The processing circuitry is configured to: execute a first encoder to extract, from the image data, a first set of features; execute a first decoder to determine, based on the first set of features, a first uncertainty score corresponding to a first confidence that the first set of features accurately represent the image data; execute a second encoder to extract, from the position data, a second set of features; execute a second decoder to determine, based on the second set of features, a second uncertainty score corresponding to a second confidence that the second set of features accurately represent the position data; and fuse the first set of features and the second set of features based on the first uncertainty score and the second uncertainty score to generate a fused set of features.

Clause 2—The system of Clause 1, wherein by executing the first encoder to extract the first set of features, the processing circuitry is configured to determine a first activation density representing a ratio of a number of active nodes of the first encoder to a total number of nodes in the first encoder, wherein by executing second encoder to extract the second set of features, the processing circuitry is configured to determine a second activation density representing a ratio of a number of active nodes of the second encoder to a total number of nodes in the first encoder, and wherein the processing circuitry is configured to fuse the first set of features and the second set of features based on the first activation density and the second activation density to generate the fused set of features.

Clause 3—The system of Clause 2, wherein to fuse the first set of features and the second set of features, the processing circuitry is configured to: calculate a first reweight value based on the first activation density and the first uncertainty score; calculate a second reweight value based on the second activation density and the second uncertainty score; generate a first set of reweighed features based on the first set of features and the first reweight value; generate a second set of reweighed features based on the second set of features and the second reweight value; and fuse the first set of reweighed features and the second set of reweighed features to generate the fused set of features.

Clause 4—The system of Clause 3, wherein to calculate the first reweight value, the processing circuitry is configured to calculate a sum of the first activation density and the first uncertainty score, wherein to calculate the second reweight value, the processing circuitry is configured to calculate a sum of the second activation density and the second uncertainty score, wherein to generate the first set of reweighed features, the processing circuitry is configured to calculate a product of the first set of features and the first reweight value, and wherein to generate the second set of reweighed features, the processing circuitry is configured to calculate a product of the second set of features and the second reweight value.

Clause 5—The system of any of Clauses 1-4, wherein the processing circuitry is further configured to execute a third decoder to generate an output based on the fused set of features.

Clause 6—The system of Clause 5, wherein the image data and the position data are representative of one or more objects, and wherein the processing circuitry is configured to use the output generated by the third decoder to control a device based on the one or more objects.

Clause 7—The system of Clause 6, wherein the processing circuitry is part of an advanced driver assistance system (ADAS).

Clause 8—The system of any of Clauses 6-7, wherein the device is a vehicle, wherein to execute the third decoder to generate the output based on the fused set of features, the processing circuitry is configured to cause the third decoder to generate the output to include information identifying one or more characteristics corresponding to each object of the one or more objects, and wherein to use the output generated by the third decoder to control the vehicle based on the one or more objects, the processing circuitry is configured to use the output generated by the third decoder to control the vehicle based on the one or more characteristics corresponding to each object of the one or more objects.

Clause 9—The system of Clause 8, wherein the one or more characteristics corresponding to each object of the one or more objects may include an identity of the object, a location of the object relative to the vehicle, one or more characteristics of a movement of the object, one or more actions performed by the object, or any combination thereof.

Clause 10—The system of any of Clauses 1-9, wherein the image data and the position data are representative of one or more objects within a three-dimensional (3D) space.

Clause 11—The system of Clause 10, wherein the processing circuitry is further configured to: project the first set of features onto a two-dimensional (2D) grid to generate a first set of bird's eye view (BEV) features that provide information from the image data corresponding to the one or more objects from a perspective looking down at the one or more objects on the 2D grid; execute the first decoder to determine the first uncertainty score based on the first set of BEV features; compress the second set of features to generate a second set of BEV features that provide information from the position data corresponding to the one or more objects from the perspective looking down at the one or more objects on a 2D space; and execute the second decoder to determine the second uncertainty score based on the second set of BEV features.

Clause 12—The system of any of Clauses 1-11, wherein the image data corresponds to one or more camera images, and wherein the position data comprises Light Detection and Ranging (LiDAR) data.

Clause 13—The system of Clause 12, wherein the system further comprises: one or more cameras configured to capture the one or more camera images; and a LiDAR system comprising: one or more light emitters configured to emit one or more optical signals; and one or more light sensors configured to sense one or more reflected optical signals corresponding to the one or more optical signals emitted by the one or more light emitters; and LiDAR processing circuitry configured to generate the position data based on the one or more optical signals emitted by the one or more light emitters and the one or more reflected optical signals sensed by the one or more light sensors.

Clause 14—A method for processing image data and position data, the method comprising: executing a first encoder to extract, from the image data, a first set of features; executing a first decoder to determine, based on the first set of features, a first uncertainty score corresponding to a first confidence that the first set of features accurately represent the image data; executing a second encoder to extract, from the position data, a second set of features; executing a second decoder to determine, based on the second set of features, a second uncertainty score corresponding to a second confidence that the second set of features accurately represent the position data; and fusing the first set of features and the second set of features based on the first uncertainty score and the second uncertainty score to generate a fused set of features.

Clause 15—The method of Clause 14, wherein by executing the first encoder to extract the first set of features, the method further comprises determining a first activation density representing a ratio of a number of active nodes of the first encoder to a total number of nodes in the first encoder, wherein by executing second encoder to extract the second set of features, the method further comprises determining a second activation density representing a ratio of a number of active nodes of the second encoder to a total number of nodes in the first encoder, and wherein the method further comprises fusing the first set of features and the second set of features based on the first activation density and the second activation density to generate the fused set of features.

Clause 16—The method of Clause 15, wherein fusing the first set of features and the second set of features comprises: calculating a first reweight value based on the first activation density and the first uncertainty score; calculating a second reweight value based on the second activation density and the second uncertainty score; generating a first set of reweighed features based on the first set of features and the first reweight value; generating a second set of reweighed features based on the second set of features and the second reweight value; and fusing the first set of reweighed features and the second set of reweighed features to generate the fused set of features.

Clause 17—The method of Clause 16, wherein calculating the first reweight value comprises calculating a sum of the first activation density and the first uncertainty score, wherein calculating the second reweight value comprises calculating a sum of the second activation density and the second uncertainty score, wherein generating the first set of reweighed features comprises calculating a product of the first set of features and the first reweight value, and wherein generating the second set of reweighed features comprises calculating a product of the second set of features and the second reweight value.

Clause 18—The method of any of Clauses 14-17, wherein the method further comprises executing a third decoder to generate an output based on the fused set of features.

Clause 19—The method of Clause 18, wherein the image data and the position data are representative of one or more objects, and wherein the method further comprises using the output generated by the third decoder to control a device based on the one or more objects.

Clause 20—The method of clause 19, wherein the device is a vehicle, wherein executing the third decoder to generate the output based on the fused set of features comprises causing the third decoder to generate the output to include information identifying one or more characteristics corresponding to each object of the one or more objects, and wherein using the output generated by the third decoder to control the vehicle based on the one or more objects comprises using the output generated by the third decoder to control the vehicle based on the one or more characteristics corresponding to each object of the one or more objects.

Clause 21—The method of Clause 20, wherein the one or more characteristics corresponding to each object of the one or more objects may include an identity of the object, a location of the object relative to the vehicle, one or more characteristics of a movement of the object, one or more actions performed by the object, or any combination thereof.

Clause 22—The method of any of Clauses 14-23, wherein the image data and the position data are representative of one or more objects within a three-dimensional (3D) space.

Clause 23—The method of Clause 22, wherein method further comprises: projecting the first set of features onto a two-dimensional (2D) grid to generate a first set of bird's eye view (BEV) features that provide information from the image data corresponding to the one or more objects from a perspective looking down at the one or more objects on the 2D grid; executing the first decoder to determine the first uncertainty score based on the first set of BEV features; compressing the second set of features to generate a second set of BEV features that provide information from the position data corresponding to the one or more objects from the perspective looking down at the one or more objects on a 2D space; and executing the second decoder to determine the second uncertainty score based on the second set of BEV features.

Clause 24—The method of any of Clauses 14-23, wherein the image data corresponds to one or more camera images, and wherein the position data comprises Light Detection and Ranging (LiDAR) data.

Clause 25—The method of any of Clauses 24, wherein the method further comprises: capturing, by one or more cameras, the one or more camera images; and emitting, by one or more light emitters of a LiDAR system, one or more optical signals; sensing, by one or more light sensors of the LiDAR system, one or more reflected optical signals corresponding to the one or more optical signals emitted by the one or more light emitters; and generating, by LiDAR processing circuitry of the LiDAR system, the position data based on the one or more optical signals emitted by the one or more light emitters and the one or more reflected optical signals sensed by the one or more light sensors.

Clause 26—A computer-readable medium comprising instructions that, when executed by processing circuitry, causes the processing circuitry to: execute a first encoder to extract, from image data, a first set of features; execute a first decoder to determine, based on the first set of features, a first uncertainty score corresponding to a first confidence that the first set of features accurately represent the image data; execute a second encoder to extract, from position data, a second set of features; execute a second decoder to determine, based on the second set of features, a second uncertainty score corresponding to a second confidence that the second set of features accurately represent the position data; and fuse the first set of features and the second set of features based on the first uncertainty score and the second uncertainty score to generate a fused set of features.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system for processing image data and position data, the system comprising:
a memory for storing the image data and the position data; and
processing circuitry in communication with the memory, wherein the processing circuitry is configured to:
apply a first encoder to extract, from the image data, a first set of features;
apply a first decoder to determine, based on the first set of features, a first uncertainty score corresponding to a first confidence that the first set of features accurately represent the image data;
apply a second encoder to extract, from the position data, a second set of features;
apply a second decoder to determine, based on the second set of features, a second uncertainty score corresponding to a second confidence that the second set of features accurately represent the position data; and
fuse the first set of features and the second set of features based on the first uncertainty score and the second uncertainty score to generate a fused set of features.

2. The system of claim 1,
wherein by executing the first encoder to extract the first set of features, the processing circuitry is configured to determine a first activation density representing a ratio of a number of active nodes of the first encoder to a total number of nodes in the first encoder,
wherein by executing second encoder to extract the second set of features, the processing circuitry is configured to determine a second activation density representing a ratio of a number of active nodes of the second encoder to a total number of nodes in the first encoder, and
wherein the processing circuitry is configured to fuse the first set of features and the second set of features based on the first activation density and the second activation density to generate the fused set of features.

3. The system of claim 2, wherein to fuse the first set of features and the second set of features, the processing circuitry is configured to:
calculate a first reweight value based on the first activation density and the first uncertainty score;
calculate a second reweight value based on the second activation density and the second uncertainty score;
generate a first set of reweighed features based on the first set of features and the first reweight value;
generate a second set of reweighed features based on the second set of features and the second reweight value; and
fuse the first set of reweighed features and the second set of reweighed features to generate the fused set of features.

4. The system of claim 3,
wherein to calculate the first reweight value, the processing circuitry is configured to calculate a sum of the first activation density and the first uncertainty score,
wherein to calculate the second reweight value, the processing circuitry is configured to calculate a sum of the second activation density and the second uncertainty score,
wherein to generate the first set of reweighed features, the processing circuitry is configured to calculate a product of the first set of features and the first reweight value, and
wherein to generate the second set of reweighed features, the processing circuitry is configured to calculate a product of the second set of features and the second reweight value.

5. The system of claim 1, wherein the processing circuitry is further configured to apply a third decoder to generate an output based on the fused set of features.

6. The system of claim 5, wherein the image data and the position data are representative of one or more objects, and wherein the processing circuitry is configured to use the output generated by the third decoder to control a device based on the one or more objects.

7. The system of claim 6, wherein the processing circuitry is part of an advanced driver assistance system (ADAS).

8. The system of claim 6,
wherein the device is a vehicle,
wherein to apply the third decoder to generate the output based on the fused set of features, the processing circuitry is configured to cause the third decoder to generate the output to include information identifying one or more characteristics corresponding to each object of the one or more objects, and
wherein to use the output generated by the third decoder to control the vehicle based on the one or more objects, the processing circuitry is configured to use the output generated by the third decoder to control the vehicle based on the one or more characteristics corresponding to each object of the one or more objects.

9. The system of claim 8, wherein the one or more characteristics corresponding to each object of the one or more objects may include an identity of the object, a location of the object relative to the vehicle, one or more characteristics of a movement of the object, one or more actions performed by the object, or any combination thereof.

10. The system of claim 1, wherein the image data and the position data are representative of one or more objects within a three-dimensional (3D) space.

11. The system of claim 10, wherein the processing circuitry is further configured to:
project the first set of features onto a two-dimensional (2D) grid to generate a first set of bird's eye view (BEV) features that provide information from the image data corresponding to the one or more objects from a perspective looking down at the one or more objects on the 2D grid;
apply the first decoder to determine the first uncertainty score based on the first set of BEV features;
compress the second set of features to generate a second set of BEV features that provide information from the position data corresponding to the one or more objects from the perspective looking down at the one or more objects on a 2D space; and
apply the second decoder to determine the second uncertainty score based on the second set of BEV features.

12. The system of claim 1, wherein the image data corresponds to one or more camera images, and wherein the position data comprises Light Detection and Ranging (LiDAR) data.

13. The system of claim 12, wherein the system further comprises:
one or more cameras configured to capture the one or more camera images; and
a LiDAR system comprising:
one or more light emitters configured to emit one or more optical signals; and
one or more light sensors configured to sense one or more reflected optical signals corresponding to the one or more optical signals emitted by the one or more light emitters; and
LiDAR processing circuitry configured to generate the position data based on the one or more optical signals emitted by the one or more light emitters and the one or more reflected optical signals sensed by the one or more light sensors.

14. A method for processing image data and position data, the method comprising:
executing a first encoder to extract, from the image data, a first set of features;
executing a first decoder to determine, based on the first set of features, a first uncertainty score corresponding to a first confidence that the first set of features accurately represent the image data;
executing a second encoder to extract, from the position data, a second set of features;
executing a second decoder to determine, based on the second set of features, a second uncertainty score corresponding to a second confidence that the second set of features accurately represent the position data; and
fusing the first set of features and the second set of features based on the first uncertainty score and the second uncertainty score to generate a fused set of features.

15. The method of claim 14,
wherein by executing the first encoder to extract the first set of features, the method further comprises determining a first activation density representing a ratio of a number of active nodes of the first encoder to a total number of nodes in the first encoder,
wherein by executing second encoder to extract the second set of features, the method further comprises determining a second activation density representing a ratio of a number of active nodes of the second encoder to a total number of nodes in the first encoder, and
wherein the method further comprises fusing the first set of features and the second set of features based on the first activation density and the second activation density to generate the fused set of features.

16. The method of claim 15, wherein fusing the first set of features and the second set of features comprises:
calculating a first reweight value based on the first activation density and the first uncertainty score;
calculating a second reweight value based on the second activation density and the second uncertainty score;
generating a first set of reweighed features based on the first set of features and the first reweight value;
generating a second set of reweighed features based on the second set of features and the second reweight value; and
fusing the first set of reweighed features and the second set of reweighed features to generate the fused set of features.

17. The method of claim 16,
wherein calculating the first reweight value comprises calculating a sum of the first activation density and the first uncertainty score,
wherein calculating the second reweight value comprises calculating a sum of the second activation density and the second uncertainty score,
wherein generating the first set of reweighed features comprises calculating a product of the first set of features and the first reweight value, and
wherein generating the second set of reweighed features comprises calculating a product of the second set of features and the second reweight value.

18. The method of claim 14, wherein the method further comprises executing a third decoder to generate an output based on the fused set of features.

19. The method of claim 18, wherein the image data and the position data are representative of one or more objects, and wherein the method further comprises using the output generated by the third decoder to control a device based on the one or more objects.

20. The method of claim 19,
wherein the device is a vehicle,
wherein executing the third decoder to generate the output based on the fused set of features comprises causing the third decoder to generate the output to include information identifying one or more characteristics corresponding to each object of the one or more objects, and
wherein using the output generated by the third decoder to control the vehicle based on the one or more objects comprises using the output generated by the third decoder to control the vehicle based on the one or more characteristics corresponding to each object of the one or more objects.

21. The method of claim 20, wherein the one or more characteristics corresponding to each object of the one or more objects may include an identity of the object, a location of the object relative to the vehicle, one or more characteristics of a movement of the object, one or more actions performed by the object, or any combination thereof.

22. The method of claim 14, wherein the image data and the position data are representative of one or more objects within a three-dimensional (3D) space.

23. The method of claim 22, wherein method further comprises:
projecting the first set of features onto a two-dimensional (2D) grid to generate a first set of bird's eye view (BEV) features that provide information from the image data corresponding to the one or more objects from a perspective looking down at the one or more objects on the 2D grid;
executing the first decoder to determine the first uncertainty score based on the first set of BEV features;
compressing the second set of features to generate a second set of BEV features that provide information from the position data corresponding to the one or more objects from the perspective looking down at the one or more objects on a 2D space; and
executing the second decoder to determine the second uncertainty score based on the second set of BEV features.

24. The method of claim 14, wherein the image data corresponds to one or more camera images, and wherein the position data comprises Light Detection and Ranging (LiDAR) data.

25. The method of claim 24, wherein the method further comprises:
capturing, by one or more cameras, the one or more camera images; and
emitting, by one or more light emitters of a LiDAR system, one or more optical signals;
sensing, by one or more light sensors of the LiDAR system, one or more reflected optical signals corresponding to the one or more optical signals emitted by the one or more light emitters; and
generating, by LiDAR processing circuitry of the LiDAR system, the position data based on the one or more optical signals emitted by the one or more light emitters and the one or more reflected optical signals sensed by the one or more light sensors.

26. A computer-readable medium storing instructions that, when applied by processing circuitry, causes the processing circuitry to:
apply a first encoder to extract, from image data, a first set of features;
apply a first decoder to determine, based on the first set of features, a first uncertainty score corresponding to a first confidence that the first set of features accurately represent the image data;
apply a second encoder to extract, from position data, a second set of features;
apply a second decoder to determine, based on the second set of features, a second uncertainty score corresponding to a second confidence that the second set of features accurately represent the position data; and
fuse the first set of features and the second set of features based on the first uncertainty score and the second uncertainty score to generate a fused set of features.
